(19) United States
(12) Patent Application Publication
(10) Pub. No.: US 2025/0199706 A1
(43) Pub. Date: Jun. 19, 2025

(54) UPGRADE OF DISTRIBUTED DATA GRID WITH NO STATE TRANSFER

(71) Applicant: Red Hat, Inc., Raleigh, NC (US)

(72) Inventors: Vittorio Rigamonti, Milan (IT); Paolo Antinori, Milan (IT)

(21) Appl. No.: 18/538,257

(22) Filed: Dec. 13, 2023

(51) Int. Cl. G06F 3/06

(52) U.S. Cl. CPC G06F 3/065; G06F 3/0604; G06F 3/067

(57) ABSTRACT

A method of receiving an update for a first node of a cluster of compute nodes, generating a second node including the update for the first node, copying data from the first node to the second node, and in response to completion of copying the data, replacing the first node in the cluster with the second node.

### TECHNICAL FIELD

Aspects of the present disclosure relate upgrade of nodes of a data grid, and more particularly, upgrading nodes of a distributed data grid with no state transfer and no rebalancing.

### BACKGROUND

Distributed data grid systems distribute and store data across various nodes of the system. For example, a distributed data grid system may use a hashing algorithm to balance the stored data across the nodes of the system.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram that illustrates a component diagram of an illustrative example of a computer system architecture, in accordance with some embodiments.

FIG. 2A depicts an example data grid system, according to some embodiments.

FIG. 2B depicts an example data grid system using a replacement node for updating a node of the system, according to some embodiments.

FIG. 2C depicts an example data grid system upgrade with a replacement node, according to some embodiments.

FIG. 3 depicts a component diagram of an example system for updating a node of a computing cluster using a replacement node, according to some embodiments.

FIG. 4 depicts a flow diagram of an example method of updating a node of a computing cluster using a replacement node, according to some embodiments.

FIG. 5 depicts a flow diagram of another example method of updating a node of a distributed data grid system using a replacement node, according to some embodiments.

FIG. 6 is a block diagram of an example apparatus that may perform one or more of the operations described herein, in accordance with some embodiments of the present disclosure.

### DETAILED DESCRIPTION

In a distributed data grid system, a consistent hashing algorithm is used to distribute data entries among the nodes. The distribution of data therefore depends on the number of nodes included in the system. The use of a consistent hashing algorithm also invokes a rebalancing process for the data when a node is added or removed to match the distribution of data with the new topology after the addition or removal of the node. Rebalancing of the data of the system then requires action by each node in the network to transfer data to the new appropriate node for the hashing algorithm. Accordingly, the rebalancing may be a massive redistribution of entries among the nodes and can utilize a large amount of computing resources and may be network intensive.

When a data grid is deployed across a computing cluster and the computing cluster needs to be upgraded to a new version or otherwise updated (e.g., without changing the topology of the data grid) each node of the computing cluster may be updated. Conventional computing clusters are updated via a rolling upgrade where each node is individually shutdown, upgraded, and then restarted one node at a time. Because the cluster topology is changed during the upgrade of a node due to the shutdown, a cluster rebalancing process is performed for the upgrade of each node. Accordingly, the performance of the cluster may be degraded due to the rebalancing that is performed for every node of the cluster during an upgrade or update.

Aspects of the disclosure address the above-noted and other deficiencies by providing an upgrade of a data grid deployed to a computing cluster with no topology change and thus no state transfer or rebalancing. In particular, embodiments may provide an upgrade manager in a computing cluster that, for each node in the cluster, generates a replacement node that includes the upgrade without connecting the replacement node to the cluster and without removing or shutting down the node to be updated. The upgrade manager may then initiate a connection between the replacement node and the target node. The data stored at the target node may then be copied to the replacement node. Once the date is completely copied, the upgrade manager may remove the target node from the cluster and add the replacement node in place of the target node. Accordingly, the topology of the data grid is maintained constant and therefore requires no rebalancing of data between the nodes due to an upgrade.

In some examples, each node of the cluster may be configured to expose a readiness endpoint which may indicate whether the node is ready and operable to be coupled to the cluster. For example, the upgrade manager may ping the readiness endpoint of a node to determine whether the node is in operation with the cluster or ready to be connected to the cluster. For example, during the upgrade of a target node, the replacement node may be generated and the readiness endpoint of the replacement node may be set to indicate “not ready” while the target node is set to “ready”. Once the data is fully copied from the target node to the replacement node, the readiness endpoint of the replacement node may be updated to indicate “ready” while the target node is updated to indicate “not ready”. The upgrade manager may use the status of the readiness endpoint to replace the target node with the replacement node within the cluster.

In some examples, to replace the target node with the replacement node after the data has been copied to the replacement node, the upgrade manager may reconfigure the services of the computing cluster to point to the replacement node. For example, the upgrade manager may update service labels of the target node at a control plane and/or master node of the computing cluster from the target node to the replacement node. In some examples, after the upgrade manager transfers the service labels to the replacement node, or otherwise replaces the target node with the replacement node within the cluster, the upgrade manager may cause the target node to be shut down.

Embodiments of the present disclosure provide advantages over existing technology by reducing the computational resources required to upgrade a data grid deployed to a computing cluster. Upgrades for a cluster in which the same cluster is deployed with new software can be performed without affecting topology of the cluster and can thus be performed with no cluster rebalancing and no state transfer. Accordingly, upgrades may be performed significantly faster than via convention methods and may reduce errors due to large numbers of rebalancing processes and state transfers.

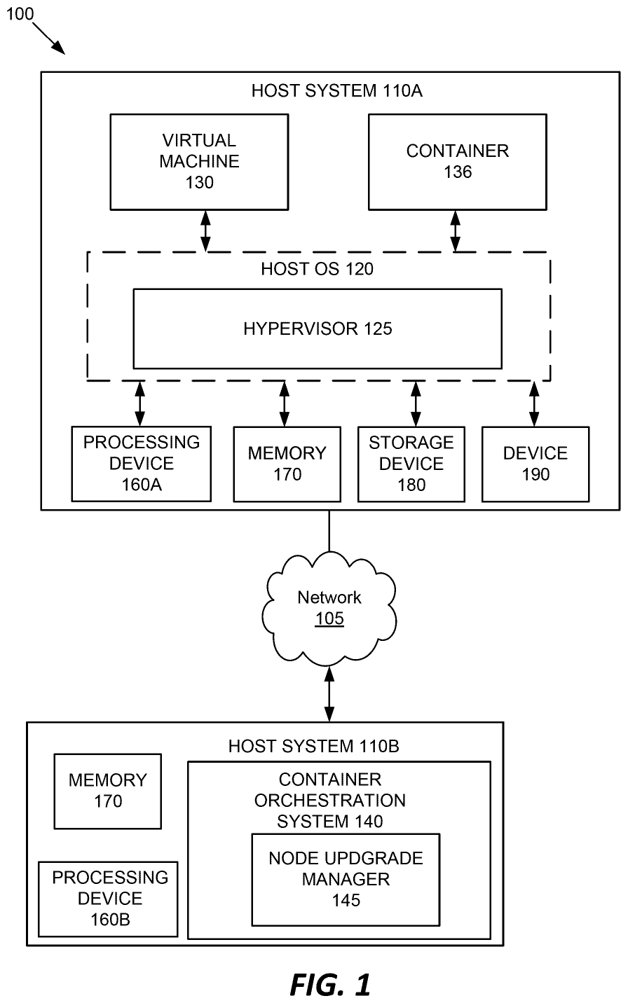

FIG. 1 FIG. 1 depicts a high-level component diagram of an illustrative example of a computer system architecture 100, in accordance with one or more aspects of the present disclosure. One skilled in the art will appreciate that other computer system architectures 100 are possible, and that the implementation of a computer system utilizing examples of the invention are not necessarily limited to the specific architecture depicted by FIG. 1.

As shown in FIG. 1, computer system architecture 100 includes host systems 110a and b coupled via a network 105. The host systems 110a and 110b may each include one or more processing devices 160, b, memory 170, which may include volatile memory devices (e.g., random access memory (RAM)), non-volatile memory devices (e.g., flash memory) and/or other types of memory devices, a storage device 180 (e.g., one or more magnetic hard disk drives, a Peripheral Component Interconnect [PCI] solid state drive, a Redundant Array of Independent Disks [RAID] system, a network attached storage [NAS] array, etc.), and one or more devices 190 (e.g., a Peripheral Component Interconnect [PCI] device, network interface controller (NIC), a video card, an I/O device, etc.). In certain implementations, memory 170 may be non-uniform access (NUMA), such that memory access time depends on the memory location relative to processing device 160. It should be noted that although, for simplicity, a single processing device 160, storage device 180, and device 190 are depicted in FIG. 1, other embodiments of host systems 110a, b and scaling system 140 may include a plurality of processing devices, storage devices, and devices. The host systems 110a, b may be a server, a mainframe, a workstation, a personal computer (PC), a mobile phone, a palm-sized computing device, etc. In embodiments, host systems 110a and 110b may be separate computing devices. In some embodiments, host systems 110a and 110b may be implemented by a single computing device. For clarity, some components of host system 110b are not shown. Furthermore, although computer system architecture 100 is illustrated as having two host systems, embodiments of the disclosure may utilize any number of host systems.

Host systems 110a and 110b may additionally include one or more virtual machines (VMs) 130, containers 136, and host operating system (OS) 120. VM 130 is a software implementation of a machine that executes programs as though it was an actual physical machine. Container 136 acts as isolated execution environments for different functions of applications, such as for nodes of an in-memory storage data grid. Host OS 120 manages the hardware resources of the computer system and provides functions such as inter-process communication, scheduling, memory management, and so forth.

Host OS 120 may include a hypervisor 125 (which may also be known as a virtual machine monitor (VMM)), which provides a virtual operating platform for VMs 130 and manages their execution. Hypervisor 125 may manage system resources, including access to physical processing devices (e.g., processors, CPUs, etc.), physical memory (e.g., RAM), storage device (e.g., HDDs, SSDs), and/or other devices (e.g., sound cards, video cards, etc.). The hypervisor 125, though typically implemented in software, may emulate and export a bare machine interface to higher level software in the form of virtual processors and guest memory. Higher level software may comprise a standard or real-time OS, may be a highly stripped down operating environment with limited operating system functionality, and/or may not include traditional OS facilities, etc. Hypervisor 125 may present other software (i.e., “guest” software) the abstraction of one or more VMs that provide the same or different abstractions to various guest software (e.g., guest operating system, guest applications). It should be noted that in some alternative implementations, hypervisor 125 may be external to host OS 120, rather than embedded within host OS 120, or may replace host OS 120.

The host systems 110a and 110b are coupled to each other (e.g., may be operatively coupled, communicatively coupled, may communicate data/messages with each other) via network 105. Network 105 may be a public network (e.g., the internet), a private network (e.g., a local area network (LAN) or wide area network (WAN)), or a combination thereof. In one embodiment, network 105 may include a wired or a wireless infrastructure, which may be provided by one or more wireless communications systems, such as a WiFi™ hotspot connected with the network 105 and/or a wireless carrier system that can be implemented using various data processing equipment, communication towers (e.g., cell towers), etc. The network 105 may carry communications (e.g., data, message, packets, frames, etc.) between the various components of host systems 110a and b.

In embodiments, host system 100b may execute a container orchestration system 140. Container orchestration system 140 may manage the deployment and operation of containers within the host systems 110b and 110a, and across any other addition host systems. For example, the container orchestration system 140 may deploy several containers acting as nodes of a distributed in-memory data grid. In some examples, data may be distributed and stored at the various containers based on a hashing algorithm applied to the data to be stored. Additionally, the container orchestration system 140 may include a node upgrade manager 145 for updating the nodes (i.e., containers) of the data grid with upgraded software.

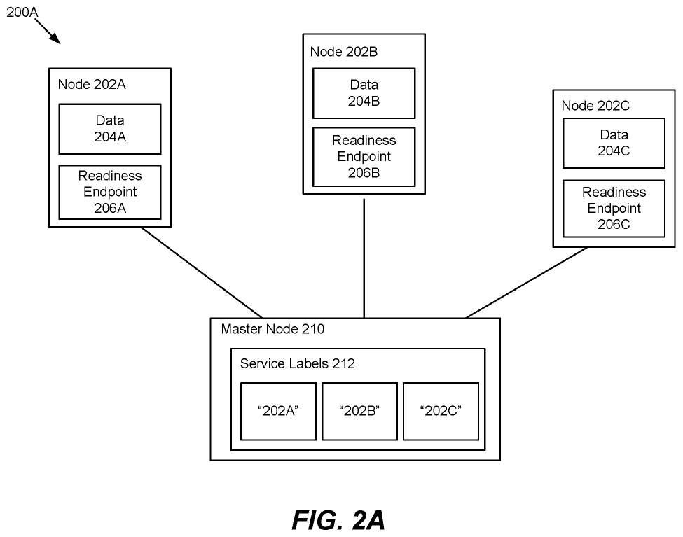

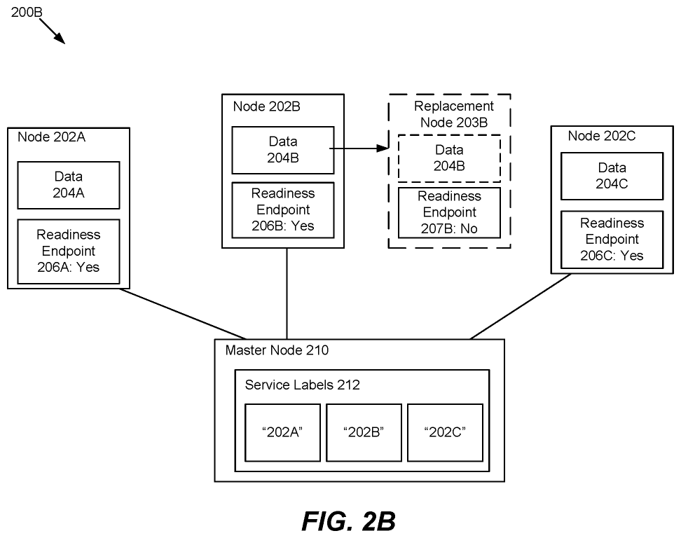

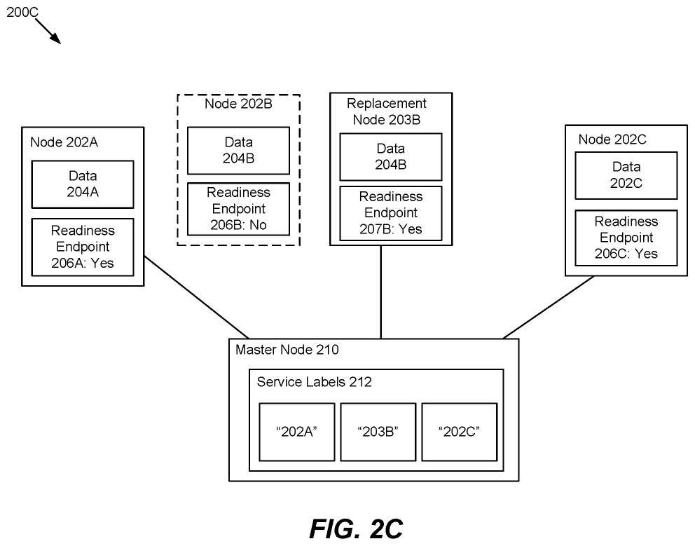

In some embodiments, the node upgrade manager 145 determines that an upgrade or update for software of the containers (e.g., container 136) of the data grid is available for the nodes of the grid. For each node, the node upgrade manager 145 generates a replacement node for the particular target node (i.e., the node being updated). The replacement node includes the upgrade but is not initially connected into the cluster supporting the data grid. The node upgrade manager 145 may then initiate a connection between the target node and the replacement node and copy the data stored at the target node to the replacement node. Once the data is copied over the replacement node, the node upgrade manager 145 may update the cluster metadata (e.g., service labels) of the container orchestration system 140 to add the replacement node into the cluster and remove the target node from the cluster. Further details regarding the node upgrade manager 145 will be discussed at FIGS. 2-5 below.

FIG. 2A depicts an example configuration 200A of a distributed data grid in which node upgrades are performed with no state transfer or data redistribution, according to some embodiments. In some examples, the distributed data grid in configuration 200A may include nodes 202A, 202B, and 202C as well as a master node 210. The master node 210 may include a control plane for managing the other nodes 202A-C of the configuration. In some embodiments, the configuration 200A of nodes 202A-C may support a distributed data grid to store data across the various nodes 202A-C. For example, the data grid may distribute data to the nodes 202A-C of the cluster using a hashing algorithm (e.g., a consistent hashing algorithm) that distributes data to a corresponding node based on a hash of the data to be stored. The hash may depend on the number of nodes in the cluster configuration and therefore a change in the topology or configuration may give rise to a redistribution of the data. In some examples, an upgrade of the software of the nodes 202A-C may be provided to an orchestration system and/or the master node 210 managing the cluster to upgrade the software deployed by the nodes 202A-C.

As depicted in FIG. 2A, the master node 210 may execute one or more services which include service labels 212 to map the services to the nodes 202A-C, respectively, and to identify the location of the nodes irrespective of the address of the nodes. For example, the service labels 212 may provide for an abstraction of the location of the nodes 202A-C such that they are replaceable in the cluster via the service labels without requiring knowledge of the new locations of the nodes (i.e., the service labels provide a mapping from service to node based on the label). According to the configuration 200A, the service labels 212 may point to the nodes 202A, 202B, and 202C, respectively, prior to the occurrence of an upgrade of the nodes.

FIG. 2B depicts an example configuration 200B of a distributed data grid in which a replacement node has been generated, according to some embodiments. In some embodiments, a node upgrade manager of the cluster may generate a replacement node for each node 202A-C in the configuration 200B that includes the upgrade or updated software for the cluster. As depicted in FIG. 2B, a replacement node 203B is generated for node 202B. The replacement node 203B may include the upgrade for the software of node 202B. Additionally, the upgrade manager may initiate a connection between node 202B and 203B and copy data 204B to the replacement node 203B. During this operation, node 202B remains operational and is maintained within the data grid to provide access to data 204B. Accordingly, the node 202B may expose a readiness endpoint 206B that indicates that node 202B is operational within the data grid. Additionally, while the data 204B is being copied (e.g., duplicated) from node 202B to 203B, the readiness endpoint 207B of replacement node 203B is set to indicate that it is not operational or otherwise not ready to be connected to the cluster. While FIG. 2B depicts only the addition of replacement node 203B, it should be noted that a replacement node may be generated for each node in the cluster deploying the data grid. For example, in the present example of FIG. 2B, a replacement node may also be generated for node 202A and 202C for updating the software of all nodes of the cluster or a subset of the nodes of the cluster that are to be updated or upgraded. Additionally, the additional nodes 202A and 202C may expose readiness endpoints 206A and 206C in a similar manner as node 202B, for monitoring and updating the nodes 202A and 202C.

FIG. 2C depicts an example configuration 200C of a distributed data grid in which a node has been replaced by a replacement node with an upgrade, according to some embodiments. After the data 204B has been successfully copied to the replacement node 203B, as described in FIG. 2B, the upgrade manager may add the replacement node 203B to the cluster and remove the original node 202B. In some examples, the readiness endpoint 207B of the replacement node 203B is updated to indicate that it is ready to be connected to the cluster while the readiness endpoint 206B of node 202B may be updated to indicated that it is not operational and therefore ready to be removed from the cluster. Accordingly, the upgrade manager may, in response to the update of the readiness endpoints 206B and 207B, update the metadata of the cluster to point to the replacement node 203B rather than node 202B. For example, the service labels 212 of the services deployed by the orchestration system (e.g., to master node 210) may be updated to correspond to a label of the replacement node 203B. For example, a service label 212 may be updated to include “203B” rather than “202B”. It should be noted that the service labels may be any label defined for a node of a cluster and the labels depicted are merely examples selected for simplicity of description. Once the service labels, or other binding metadata is updated, the replacement node 203B may operate in place of node 202B within the data grid with the updated or upgraded software. Accordingly, the topology of the cluster does not change and no state transfer or data redistribution is required. In some examples, after removing the node 202B from the cluster, the node 202B may be shut down.

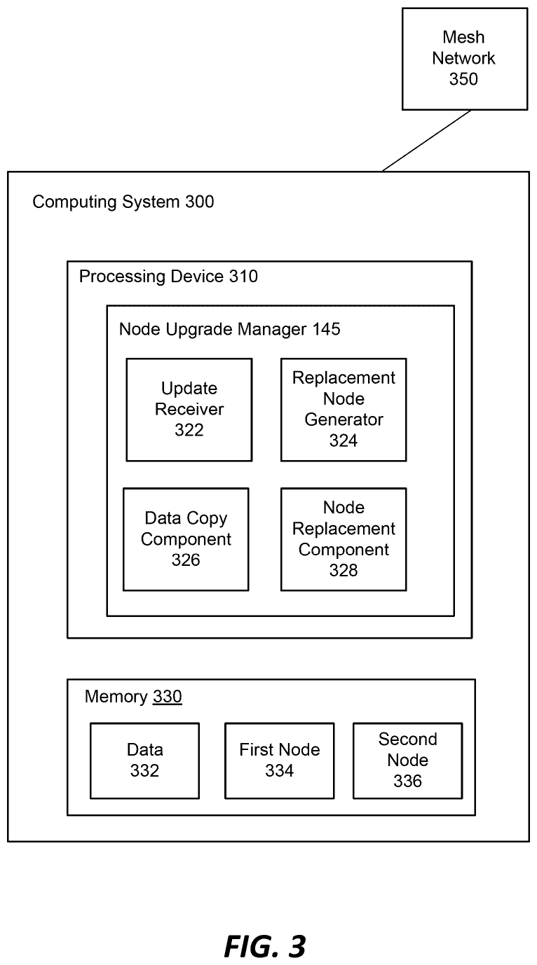

FIG. 3 is a block diagram that illustrates a computing system 300 for updating a node of a computing cluster deploying an in-memory data grid using a replacement node, according to some embodiments. Computing system 300 may include a processing device 310 and memory 330. Memory 330 may include volatile memory devices (e.g., random access memory (RAM)), non-volatile memory devices (e.g., flash memory) and/or other types of memory devices. Processing device 310 may be a central processing unit (CPU) or other processing device of computing system 300. Computing device 300 may be coupled to a mesh network 350. The mesh network 350 may include several computing nodes in communication with one another.

In one example, the processing device 310 may execute a node upgrade manager 145 for upgrading nodes of a distributed data grid without state transfer or redistribution. Node upgrade manager 320 may include an update receiver 322, a replacement node generator 324, a data copy component 326, and a node replacement component 328. In some examples, the update receiver 322 may receive, obtain, or otherwise identify an update or upgrade of software to be deployed to a first node 334 of a data grid (e.g., one or more nodes of a cluster of containers on which the data grid is deployed). The replacement node generator 324 may generate an additional node (e.g., second node 336) that includes the identified update. For example, the replacement node generator 324 may spin up a new node based on the updated software. However, the second node 336 is not yet added to the cluster. First, the data copy component 326 copies the data 332 of the data grid that has been distributed to the first node 334 (otherwise referred to herein as the target node) over to the second node 336 (otherwise referred to herein as the replacement node). While the data copy component 326 duplicates the data 332 of the first node 334 to the second node 336, the first node continues to operate as normal within the cluster to provide uninterrupted access to the data of the data grid. Once the data copy component 326 completes the data duplication to the second node 336, the node replacement component 328 removes the first node 334 from the cluster and replaces it with the second node 336. For example, adding the second node 336 and removing the first node 334 may include updating metadata of the cluster to point to the second node 336 rather than the first node 334. Accordingly, the update and replacement of the first node 334 may be done without any change in topology of the cluster and therefore without any state transfers or data redistribution.

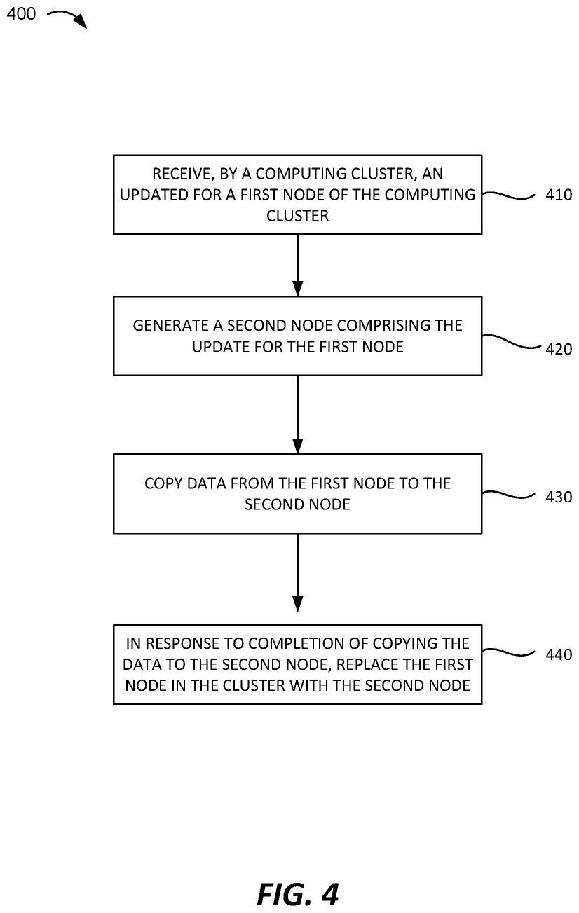

FIG. 4 is a flow diagram of a method 400 of updating a node of a computing cluster deploying an in-memory data grid using a replacement node, in accordance with one or more aspects of the disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by node upgrade manager 145 of at least FIG. 1 and/or FIG. 3.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where processing logic receives an update for a first node of a computing cluster. In some examples, the cluster includes an in-memory data storage cluster (e.g., data grid) in which data is distributed across the node of the cluster in view of a consistent hash operation.

At block 420, processing logic generates a second node comprising the update for the first node. For example, the processing logic may instantiate a new container from an image that includes the updated software.

At block 430, processing logic copies data from the first node to the second node. In some embodiments, to copy the data the processing logic establishes a connection between the first node and the second node. The processing logic may further identify in-memory data of the first node and copy the in-memory data from the first node to the second node via the established connection.

At block 440, in response to completion of copying the data to the second node, processing logic replaces the first node in the cluster with the second node. In some examples, replacing the first node with the second node includes updating service labels of the cluster to include the second node in place of the first node. In some examples, processing logic further updates a first indicator of the second node to indicate that the second node has received all data from the first node. In response to updating the first indicator of the second node, the processing logic updates a second indicator of the first node to indicate that the first node is no longer available to the cluster. The first indicator may be a readiness endpoint of the second node and the second indicator may be a readiness endpoint of the first node. The processing logic may further delete the first node in response to replacing the first node with the second node in the cluster.

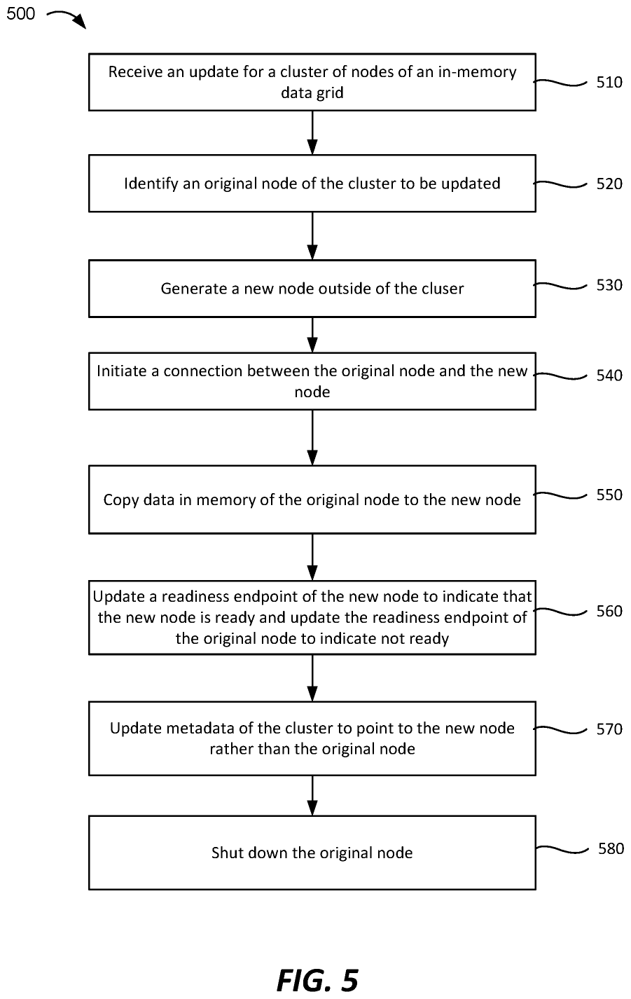

FIG. 5 is a flow diagram of a method 500 of updating a node of a computing cluster deploying an in-memory data grid using a replacement node, in accordance with one or more aspects of the disclosure. Method 500 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by node upgrade manager 145 of at least FIG. 1 and/or FIG. 3.

With reference to FIG. 5, method 500 illustrates example functions used by various embodiments. Although specific function blocks (“blocks”) are disclosed in method 500, such blocks are examples. That is, embodiments are well suited to performing various other blocks or variations of the blocks recited in method 500. It is appreciated that the blocks in method 500 may be performed in an order different than presented, and that not all of the blocks in method 500 may be performed.

Method 500 begins at block 502, where processing logic receives an update for a cluster of nodes of a data grid. For example, a cluster of containers (e.g., a Kubernetes™ cluster) may be deployed as a distributed data grid to store data in-memory of computer system. The software deployed by the containers of the cluster for the data grid may be updated or upgraded when new versions of the software are developed and deployed to the cluster. The update may be applied to one of the nodes, a subset of the nodes, or every node of the cluster.

At block 520, processing logic identifies an original node of the cluster to be updated. For example, the processing logic may identify one of the nodes that is to be updated and that has not yet been updated. In some examples, the processing logic may iterate over each of the nodes to be updated and perform each of the steps provided herein to update each of the nodes.

At block 530, processing logic generates a new node outside of the cluster. For example, the processing logic may instantiate a new container from an image that includes the updated or upgraded software for the node. In some examples, the new node may yet not be added to the cluster until all data from the original node is duplicated to the new node at block 550 below.

At block 540, processing logic initiates a connection between the original node and the new node. For example, the processing logic may initiate a network connection between the original node and the new node. In some examples, the network connection may include a bridge network, an overlay network, vlan network, or any other network for communication between containers.

At block 550, processing logic copies data in memory of the original node to the new node. For example, the processing logic may duplicate all the data stored at the original node of the data grid to the new node. Accordingly, the new node may be a duplicate of the original node except with the upgraded software for the data grid.

At block 560, processing logic updates a readiness endpoint of the new node to indicate that the new node is ready and a readiness endpoint of the original node to indicate that it is not ready (e.g., no longer operational and ready to be removed from the cluster). The readiness endpoints (e.g., a readiness probe) may indicate whether the nodes are ready or available to accept traffic. In some examples, the readiness endpoints may provide a message periodically to the master node or control plane of the cluster to indicate whether the node is ready to receive traffic. In other examples, the control plane may query the readiness endpoints periodically to determine if the nodes are ready and available to receive traffic. Accordingly, upon updating the readiness endpoint of the new node to indicate that it is ready and the readiness endpoint of the original node to indicate not ready, the master node and control plane may determine that the new node is ready to be added to the cluster and that the original node is to be removed.

At block 570, processing logic updates metadata of the cluster to point to the new node rather than the original node. In some embodiments, updating the metadata includes updating the service labels for the service or services of the original node to reference and point to the new node. Accordingly, the services of the container cluster may be updated with a new label to include the new node within the cluster. At block 580, processing logic shuts down the original node. In some examples, the processing logic deletes the original node and the data included within the original node.

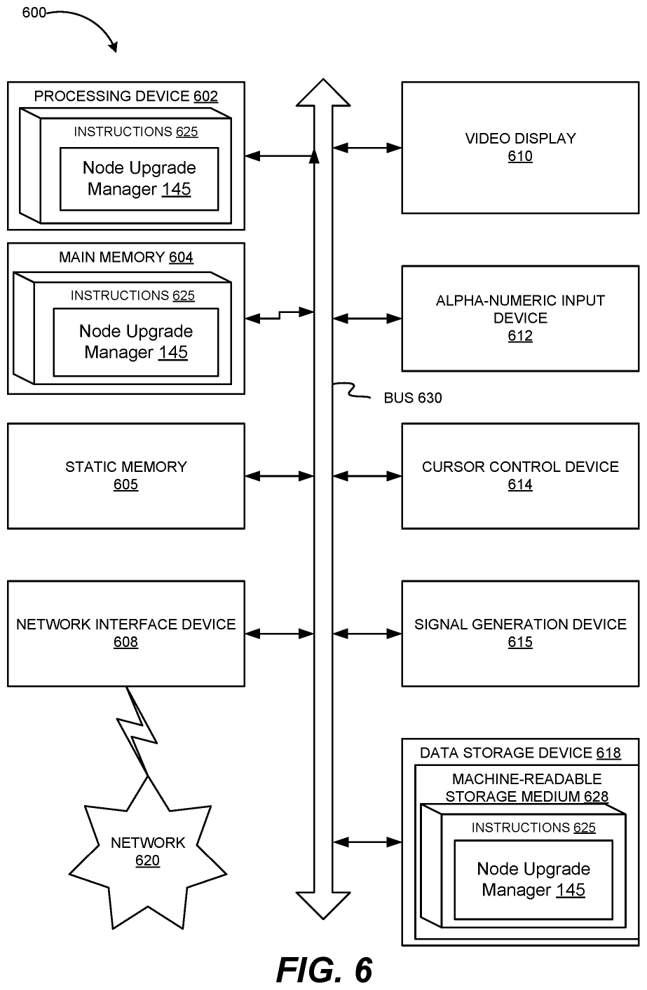

FIG. 6 is a block diagram of an example computing device 600 that may perform one or more of the operations described herein, in accordance with some embodiments. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device (e.g., a general purpose processor, a PLD, etc.) 602, a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also comprise one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a computer-readable storage medium 628 on which may be stored one or more sets of instructions 625 that may include instructions for a node upgrade manager, e.g., node upgrade manager 145, for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “generating,” “copying,” “replacing,” “updating” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving an update for a first node of a cluster of compute nodes;
generating, by a processing device, a second node comprising the update for the first node, wherein the second node is generated based on an image comprising the update for the first node;
copying data from the first node to the second node; and
in response to completion of copying the data, replacing the first node in the cluster with the second node and exposing a readiness endpoint of the second node to indicate connection of the second node to the cluster.

2. The method of claim 1, wherein replacing the first node with the second node comprises:
updating service labels of the cluster to include the second node in place of the first node.

3. The method of claim 1, wherein replacing the first node with the second node comprises:
updating a first indicator of the second node to indicate that the second node has received all the data from the first node; and
in response to updating the first indicator of the second node, updating a second indicator of the first node to indicate that the first node is no longer available to the cluster.

4. The method of claim 3, wherein the first indicator is the readiness endpoint of the second node and the second indicator is a readiness endpoint of the first node.

5. The method of claim 1, wherein the cluster comprises an in-memory data grid in which data is distributed across nodes of the cluster in view of a consistent hash operation.

6. The method of claim 1, further comprising:
deleting the first node in response to replacing the first node with the second node in the cluster.

7. The method of claim 1, wherein copying data from the first node to the second node comprises:
establishing a connection between the first node and the second node;
identifying in-memory data of the first node; and
copying the in-memory data from the first node to the second node via the connection.

8. A system comprising:
a memory; and
a processing device, operatively coupled to the memory, to:
receive an update for a first node of a cluster of compute nodes;
generate a second node comprising the update for the first node, wherein the second node is generated based on an image comprising the update for the first node;
copy data from the first node to the second node; and
in response to completion of copying the data, replace the first node in the cluster with the second node and expose a readiness endpoint of the second node to indicate connection of the second node to the cluster.

9. The system of claim 8, wherein to replace the first node with the second node, the processing device is to:
update service labels of the cluster to include the second node in place of the first node.

10. The system of claim 8, wherein to replace the first node with the second node, the processing device is to:
update a first indicator of the second node to indicate that the second node has received all the data from the first node; and
in response to updating the first indicator of the second node, update a second indicator of the first node to indicate that the first node is no longer available to the cluster.

11. The system of claim 10, wherein the first indicator is the readiness endpoint of the second node and the second indicator is a readiness endpoint of the first node.

12. The system of claim 8, wherein the cluster comprises an in-memory data grid in which data is distributed across nodes of the cluster in view of a consistent hash operation.

13. The system of claim 8, wherein the processing device is further to:
delete the first node in response to replacing the first node with the second node in the cluster.

14. The system of claim 8, wherein to copy data from the first node to the second node, the processing device is to:
establish a connection between the first node and the second node;
identify in-memory data of the first node; and
copy the in-memory data from the first node to the second node via the connection.

15. A non-transitory computer-readable storage medium including instructions that, when executed by a processing device, cause the processing device to:
receive an update for a first node of a cluster of compute nodes;
generate, by the processing device, a second node comprising the update for the first node, wherein the second node is generated based on an image comprising the update for the first node;
copy data from the first node to the second node; and
in response to completion of copying the data, replace the first node in the cluster with the second node and expose a readiness endpoint of the second node to indicate connection of the second node to the cluster.

16. The non-transitory computer-readable storage medium of claim 15, wherein to replace the first node with the second node, the processing device is to:
update service labels of the cluster to include the second node in place of the first node.

17. The non-transitory computer-readable storage medium of claim 15, wherein to replace the first node with the second node, the processing device is to:
update a first indicator of the second node to indicate that the second node has received all the data from the first node; and
in response to updating the first indicator of the second node, update a second indicator of the first node to indicate that the first node is no longer available to the cluster.

18. The non-transitory computer-readable storage medium of claim 17, wherein the first indicator is the readiness endpoint of the second node and the second indicator is a readiness endpoint of the first node.

19. The non-transitory computer-readable storage medium of claim 15, wherein the cluster comprises an in-memory data grid in which data is distributed across nodes of the cluster in view of a consistent hash operation.

20. The non-transitory computer-readable storage medium of claim 15, wherein the processing device is further to:
delete the first node in response to replacing the first node with the second node in the cluster.
